(19) United States
(12) Patent Application Publication
(10) Pub. No.: US 2018/0237063 A1
(43) Pub. Date: Aug. 23, 2018

(54) Magnetorheological Bushing Steering System

(71) Applicant: Mahmoud Mohsen Abdelfatah, Canton, MI (US)

(72) Inventor: Mahmoud Mohsen Abdelfatah, Canton, MI (US)

(21) Appl. No.: 15/438,747

(22) Filed: Feb. 21, 2017

(51) Int. Cl. B62D 7/22; B60G 17/016; F16F 1/36

(52) U.S. Cl. CPC B62D 7/228; B60G 17/0162; F16F 1/361; B60Y 2300/022; B60G 2500/40; B60G 2204/41; F16F 1/3615

(57) ABSTRACT

A variable stiffness automotive suspension bushing (1) comprises a shaft or rod connected to a wheel member, an inner cylinder fixedly connected to the shaft or rod, and an outer cylinder fixedly connected to a chassis member. A magnetorheological (MR) elastomer, having iron particles embedded therein, is interposed between the inner and outer cylinders, and a coil is disposed about the inner cylinder. When the coil is energized by electrical current provided from a steering control module, a variable magnetic field is generated so as to influence the magnetorheological (MR) elastomer whereby variable stiffness values of the elastomer are obtained to provide the bushing (1) with variable stiffness characteristics in order to, in turn, provide the vehicle with optimal wheel deflection.

### BACKGROUND OF THE INVENTION

### Field of the Invention

This invention relates to a method and apparatus for varying the stiffness of a steering bushing in a motor vehicle. More particularly, the method and apparatus are useful for selecting a bushing stiffness to improve the stability and handling of a vehicle.

### BRIEF SUMMARY OF THE INVENTION

This present invention comprises of a plurality of magnetorheological bushings (1) and a controller that are configured to improve stability and handling of a vehicle. In one embodiment, a magnetorheological bushing (1) is coupled to a wheel of the vehicle to allow for active adjustment in the steering rate using a controller. In one embodiment, a said bushing is provided for each of the front wheels. In one embodiment, as said bushing is provided for each of the front and rear wheels.

In one embodiment, a steering and handling system comprises a magnetorheological bushing (1) having a first end coupled to the chassis of a vehicle and a second end attached to a wheel of the vehicle. In one embodiment, the magnetorheological bushing supplements the standard non-magnetorheological bushing (2) in the vehicle. In one embodiment, each such magnetorheological bushing (1) is positioned in parallel with the corresponding existing non-magnetorheological bushing (2). In one embodiment, a controller actively controls operation of the magnetorheological bushings to adjust yaw. In one embodiment, the controller actively controls operation of the magnetorheological bushings (2) for stability and handling of the vehicle.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE OF THE DRAWING

FIG. 1 is a perspective drawing of a front suspension including a system according to the present invention. This FIGURE shows various components of a system embodying the present invention.

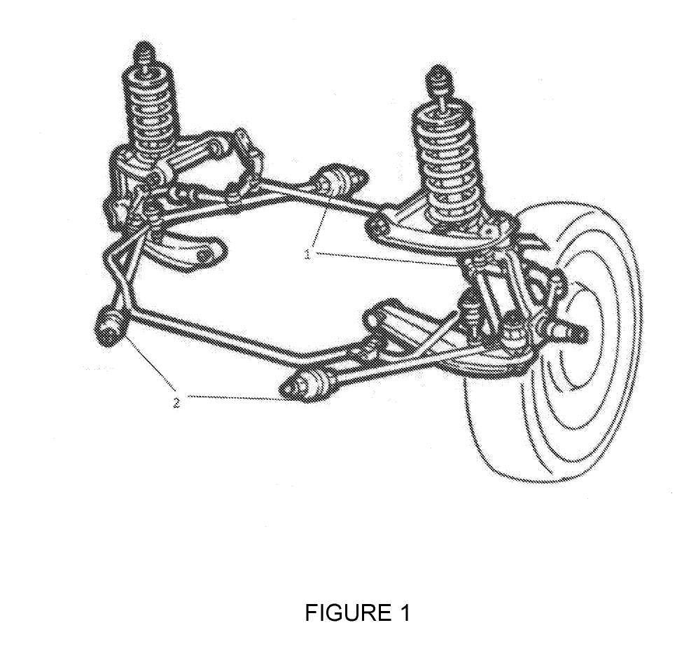

### DETAILED DESCRIPTION OF THE INVENTION

From the description herein, it will be appreciated that the invention encompasses multiple embodiments which include, but are not limited to, the following:

1. A system comprising a plurality of magnetorheological bushings (1) and a controller that are configured to improve stability and handling in vehicles.

2. An apparatus for improving stability and handling of a vehicle, the apparatus comprising: a magnetorheological bushing (1) coupled to a wheel of a vehicle; and a controller connected to the magnetorheological bushing (1) and configured for active adjustment of steering rate of the wheel.

3. The apparatus of any preceding embodiment, wherein a said magnetorheological bushing (1) is provided for each front wheel in the vehicle.

4. The apparatus of any preceding embodiment, wherein a said magnetorheological bushing (1) is provided for each front wheel and each rear wheel in the vehicle.

5. A steering and handling system for a vehicle, the system comprising: a magnetorheological bushing (1) having a first end coupled to vehicle chassis and a second end attached to a wheel of the vehicle; and a controller connected to the magnetorheological bushing and configured for active adjustment of steering rate of the wheel.

6. The system of any preceding embodiment, wherein the magnetorheological bushing (1) supplements a standard non-magnetorheological bushing (2) in the vehicle.

7. The system of any preceding embodiment, wherein each such magnetorheological a bushing (1) is positioned in parallel with a corresponding existing non-magnetorheological bushing (2).

8. The system of any preceding embodiment, wherein the controller actively controls operation of the magnetorheological bushing (1) to adjust yaw.

9. The system of any preceding embodiment, wherein the controller actively controls operation of the magnetorheological bushing (1) for stability and handling of the vehicle.

Although the description herein contains many details, these should not be construed as limiting the scope of the invention but as merely providing illustrations of some of the presently preferred embodiments. Therefore, it will be appreciated that the scope of the invention fully encompasses other embodiments which may become obvious to those skilled in the art.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, computer processor, central processing unit (CPU), and computer are used synonymously to denote a device capable of executing the instructions and communicating with input/output interfaces and/or peripheral devices, and that the terms processor, computer processor, CPU, and computer are intended to encompass single or multiple devices, single core and multicore devices, and variations thereof.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

In addition to any other claims, the applicant(s)/inventor(s) claim each and every embodiment of the technology described herein, as well as any aspect, component, or element of any embodiment described herein, and any combination of aspects, components or elements of any embodiment described herein.

1. A system comprising a plurality of magnetorheological bushings (1) and a controller that are configured to improve stability and handling in vehicles.

2. An apparatus for improving stability and handling of a vehicle, the apparatus comprising: a magnetorheological bushing (1) coupled to a wheel of a vehicle; and a controller connected to the magnetorheological bushing (2) and configured for active adjustment of steering rate of the wheel.

3. The apparatus of claim 2, wherein a said magnetorheological bushing (1) is provided for each front wheel in the vehicle.

4. The apparatus of claim 2, wherein a said magnetorheological bushing (1) is provided for each front wheel and each rear wheel in the vehicle.

5. A steering and handling system for a vehicle, the system comprising: a magnetorheological bushing (1) having a first end coupled to a vehicle chassis and a second end attached to a wheel of the vehicle; and a controller connected to the magnetorheological bushing (1) and configured for active adjustment of steering rate of the wheel.

6. The system of claim 5, wherein the magnetorheological bushing (1) supplements a standard non-magnetorheological bushing (2) in the vehicle.

7. The system of claim 5, wherein each such magnetorheological bushing (1) is positioned in parallel with a corresponding existing non-magnetorheological bushing (2).

8. The system of claim 5, wherein the controller actively controls operation of the magnetorheological bushing (1) to adjust yaw.

9. The system of claim 5, where in the controller actively controls operation of the magnetorheological bushing (1) for stability and handling of the vehicle.
